(19) United States
(12) Patent Application Publication
(10) Pub. No.: US 2026/0036781 A1
(43) Pub. Date: Feb. 5, 2026

(54) OPTICAL ELEMENT DRIVING MECHANISM

(71) Applicant: TDK Corporation, Tokyo (JP)

(72) Inventors: Chuan-Min LEE, Taoyuan City (TW); Shu-Shan Chen, Taoyuan City (TW); Pai-Jui Cheng, Taoyuan City (TW)

(73) Assignee: TDK Corporation, Tokyo (JP)

(21) Appl. No.: 19/271,327

(22) Filed: Jul. 16, 2025

(30) Foreign Application Priority Data
Aug. 2, 2024 (CN) 202421862618.4

(51) Int. Cl. G02B 7/09; G02B 13/00; H04N 23/68

(52) U.S. Cl. CPC G02B 7/09; G02B 13/001; H04N 23/687

(57) ABSTRACT

An optical element driving mechanism is provided. The optical element driving mechanism includes a fixed assembly, a movable part, and a driving assembly. The fixed assembly has a main axis. The movable part is configured to be connected to an optical element, and the movable part is movable relative to the fixed assembly. The driving assembly is configured to drive the movable part to move relative to the fixed assembly.

### CROSS REFERENCE TO RELATED APPLICATIONS

This application claims the benefit of China Patent Application No. 202421862618.4, filed on Aug. 2, 2024, the entirety of which is incorporated by reference herein.

### BACKGROUND OF THE INVENTION

### Field of the Disclosure

The present disclosure relates to an optical element driving mechanism, and in particular it relates to an optical element driving mechanism with a piezoelectric element.

### Description of the Related Art

As technology has developed, many of today's electronic devices (such as smartphones) have been equipped with cameras to provide photographic and video-recording functionality. Users can capture photographs and record videos using the camera modules disposed in their electronic devices.

Today's design of electronic devices continues to follow the trend of miniaturization, meaning that the various components of the camera module and its structure must also be continuously reduced, so as to achieve miniaturization. In general, a driving mechanism in a camera module has a camera lens holder configured to hold a camera lens, and the driving mechanism can provide the functions of auto focusing or optical image stabilization. However, although existing driving mechanisms can achieve the aforementioned functions of taking photographs and recording videos, they still cannot meet all users' needs.

Therefore, how to design a camera module that can perform autofocus, optical anti-shake and achieve miniaturization at the same time is topic nowadays that needs to be discussed and solved.

### BRIEF SUMMARY OF THE INVENTION

Accordingly, one objective of the present disclosure is to provide an optical element driving mechanism to solve the above problems.

According to some embodiments of the disclosure, an optical element driving mechanism is provided. The optical element driving mechanism includes a fixed assembly, a movable part, and a driving assembly. The fixed assembly has a main axis. The movable part is configured to be connected to an optical element, and the movable part is movable relative to the fixed assembly. The driving assembly is configured to drive the movable part to move relative to the fixed assembly.

According to some embodiments, when viewed along the main axis, the fixed assembly has a polygonal structure. When viewed along the main axis, the driving assembly is located on the first side of the polygonal structure. The optical element driving mechanism further includes a circuit assembly which is electrically connected to the driving assembly. When viewed along the main axis, the circuit assembly is located on the first side. The circuit assembly has an L-shaped structure, which includes a first circuit portion and a second circuit portion.

According to some embodiments, the optical element driving mechanism further includes a sensing assembly configured to sense the movement of the movable part. When viewed along the main axis, the sensing assembly is located on the first side. The sensing assembly includes a sensing element and a sensing magnet. The sensing magnet is disposed on the movable part. The sensing element is disposed on the first circuit portion of the circuit assembly and faces the sensing magnet. The optical element driving mechanism further includes a control circuit which is disposed on the second circuit portion. When viewed along the main axis, the second circuit portion shields the control circuit.

According to some embodiments, the driving assembly further includes a driving element, a transmission element and an enhancing element. The driving element is connected between the enhancing element and the transmission element. The driving element is configured to generate a first driving force. The transmission element has a long strip-shaped structure configured to transmit the first driving force. The enhancing element corresponds to the driving element and is configured to enhance the first driving force. The driving element has piezoelectric material. When viewed along the main axis, the extending direction of the transmission element is parallel to the first side.

According to some embodiments, the fixed assembly further includes a first receiving space, and at least a portion of the control circuit or the sensing assembly is located in the first receiving space. When viewed along the main axis, the first receiving space is located on the first side. The fixed assembly further includes a separating wall which is located between the first receiving space and the driving assembly. When viewed along the main axis, the separating wall is located on the first side.

According to some embodiments, the optical element driving mechanism further includes a central assembly which is configured to transmit the first driving force to the movable part. The central assembly includes a first transmit member and a second transmit member. The first transmit member has a long strip-shaped structure. The second transmit member corresponds to the first transmit member, and the second transmit member is movable relative to the first transmit member. The first transmit member is movable relative to the transmission element. The second transmit member is movable relative to the transmission element.

According to some embodiments, the central assembly further includes a contact member and a force applying member. The contact member is configured to clamp the transmission element. The force applying member is configured to apply a supporting force on the contact member. The optical element driving mechanism further includes a first fixed element which is configured to fix the first transmit member. The optical element driving mechanism further includes a second fixed element which is configured to fix the second transmit member. The force applying member is fixedly connected to the second fixed element and is located between the transmission element and the second fixed element. The first driving force is configured to be transmitted to the movable part through the contact member, the force applying member, the second fixed element, the second transmit member and the first transmit member.

According to some embodiments, the first fixed element includes a first surface, a first accommodation portion and a second surface. The first surface faces the second transmit member. The first accommodation portion has an opening structure which is formed on the first surface and is configured to accommodate at least a portion of the first transmit member. The second surface is not parallel to the first surface. The optical element driving mechanism further includes a first opening and a second opening. The first opening is formed on the second surface, and at least a portion of the first transmit member is exposed from the first opening. The first opening is communicated with the first accommodation portion. The second opening is formed on the first surface and adjacent to the first accommodation portion.

According to some embodiments, the optical element driving mechanism further includes a first connection element which is partially located in the first accommodation portion. The first transmit member is connected to the first fixed element via the first connection element. A first gap is formed between the first transmit member and the first accommodation portion. At least a portion of the first connection element is located in the first gap. The optical element driving mechanism further includes a second connection element which is partially located on the first opening. The second connection element is in direct contact with the first transmit member and the first fixed element. The second connection element is in direct contact with the first connection element.

According to some embodiments, the optical element driving mechanism further includes a third connection element, and at least a portion of the third connection element is located in the second opening. The third connection element is in direct contact with the first transmit member and the first fixed element. The third connection element is in direct contact with the first connection element. The third connection element does not exceed the first surface.

According to some embodiments, the central assembly further includes a first corresponding surface and a second corresponding surface. The first corresponding surface faces the first transmit member. The second corresponding surface faces the first transmit member. The first transmit member has a long strip-shaped structure which extends along a first direction. When viewed along the first direction, the first transmit member is located between the first corresponding surface and the second corresponding surface. The first corresponding surface and the second corresponding surface face different directions.

According to some embodiments, the second transmit member has a third surface and a first through groove. The first through groove is recessed from the third surface. The first transmit member passes through the first through groove. The first corresponding surface and the second corresponding surface are formed in the first through groove. The first through groove has a long strip-shaped structure. The first through groove has a first end portion and a second end portion. The first corresponding surface is located between the first end portion and the second end portion. The second corresponding surface is located between the first end portion and the second end portion.

According to some embodiments, the second transmit member further includes a first positioning portion, and the first positioning portion has a first positioning surface. The first positioning surface is not parallel to the third surface. The second transmit member further includes a second positioning portion, and the second positioning portion has a second positioning surface. The second positioning surface and the first positioning surface face different directions. The second positioning surface is not parallel to the third surface.

According to some embodiments, the optical element driving mechanism further includes a fourth connection element, and the second transmit member is connected to the second fixed element via the fourth connection element. The fourth connection element is in direct contact with the third surface. The fourth connection element is in direct contact with the first positioning surface. The fourth connection element is in direct contact with the second positioning surface.

According to some embodiments, the fixed assembly further includes a third positioning portion, and the third positioning portion has a third positioning surface. The third positioning surface and the first positioning surface face different directions. The third positioning surface is not parallel to the third surface. The fourth connection element does not contact the third positioning surface. The second transmit member is movable relative to the third positioning surface.

According to some embodiments, the second transmit member further includes a fourth positioning portion, and the fourth positioning portion has a fourth positioning surface. The fourth positioning surface and the first positioning surface face different directions. The fourth positioning surface and the second positioning surface face different directions. The fourth positioning surface and the third positioning surface face different directions. The fourth positioning surface is not parallel to the third surface.

According to some embodiments, when viewed in a direction perpendicular to the third surface, the transmission element is located between the third positioning surface and the fourth positioning surface. The Young's modulus of the first transmit member and the second transmit member are different. The first transmit member includes metal material. The second transmit member includes plastic material.

According to some embodiments, the optical element driving mechanism further includes a stopping assembly which is configured to limit the movement of the movable part within a range of motion. When the movable part is located in any position within the range of motion, the first transmit member does not contact the first end portion. When the movable part is located in any position within the range of motion, the first transmit member does not contact the second end portion. At least a portion of the stopping assembly is disposed in the movable part.

According to some embodiments, the central assembly further includes a second through groove which has a third corresponding surface facing the first transmit member. The second through groove has a fourth corresponding surface facing the first transmit member. When viewed along the extending direction of the first transmit member, the first transmit member is located between the third corresponding surface and the fourth corresponding surface. The third corresponding surface is parallel to the first corresponding surface.

According to some embodiments, the second through groove has a recessed structure or an opening structure which is formed on the second fixed element. The third corresponding surface is not connected to the first corresponding surface. There is a gap between the third corresponding surface and the first corresponding surface.

The present disclosure provides an optical element driving mechanism which includes a fixed assembly, a movable part, and a driving assembly. The movable part is movable relative to the fixed assembly, and the driving assembly is configured to drive the movable part to move relative to the fixed assembly. Furthermore, the optical element driving mechanism further includes a central assembly, and the driving assembly drives the movable part to move through the central assembly.

In some embodiments, the central assembly includes a first transmit member, a second transmit member, and a second fixed element. The first transmit member is fixedly connected to the movable part, the second transmit member is affixed to the second fixed element, and the second fixed element is sleeved on the transmission element of the driving assembly. When the driving assembly provides the first driving force, the second fixed element drives the second transmit member to move along the first axis.

Furthermore, a first through groove is formed on the second transmit member, and the first transmit member has a cylindrical structure and passes through the first through groove. When the second transmit member moves along the first axis, the first transmit member is driven to drive the movable part to move along the main axis. The extending direction of the first through groove is not parallel to the first axis or the main axis. In addition, in some embodiments, the positions of the first transmit member and the first through groove can be interchanged. For example, the first transmit member is provided on the second fixed element, and the first through groove is formed on the movable part. Therefore, the optical element driving mechanism can effectively reduce the structural size along the main axis so as to achieve the purpose of miniaturization.

Additional features and advantages of the disclosure will be set forth in the description which follows, and, in part, will be obvious from the description, or can be learned by practice of the principles disclosed herein. The features and advantages of the disclosure can be realized and obtained by means of the instruments and combinations pointed out in the appended claims. These and other features of the disclosure will become more fully apparent from the following description and appended claims, or can be learned by the practice of the principles set forth herein.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of an optical element driving mechanism 100 according to an embodiment of the present disclosure.

FIG. 2 is an exploded diagram of the optical element driving mechanism 100 according to an embodiment of the present disclosure.

FIG. 3 is a cross-sectional view of the optical element driving mechanism 100 along line A-A in FIG. 1 according to an embodiment of the present disclosure.

FIG. 4 is a top view of a partial structure of the optical element driving mechanism 100 according to an embodiment of the present disclosure.

FIG. 5 is a front view of a partial structure of the optical element driving mechanism 100 according to an embodiment of the present disclosure.

FIG. 6 is a schematic front view of the second transmit member 105 located in a first position according to an embodiment of the present disclosure.

FIG. 7 is a schematic front view of the second transmit member 105 located in a second position according to an embodiment of the present disclosure.

FIG. 8 is a three-dimensional exploded diagram of a partial structure of the optical element driving mechanism 100 according to an embodiment of the present disclosure.

FIG. 9 is a front view of a partial structure of the optical element driving mechanism 100 according to an embodiment of the present disclosure.

FIG. 10 is a front view of a partial structure of the optical element driving mechanism 100 according to an embodiment of the present disclosure.

FIG. 11 is a three-dimensional cross-sectional view of the partial structure of the optical element driving mechanism 100 along line B-B in FIG. 1 according to an embodiment of the present disclosure.

FIG. 12 is a front view of the partial structure of the optical element driving mechanism 100 according to an embodiment of the present disclosure.

FIG. 13 is an exploded diagram of a partial structure of the optical element driving mechanism 100 according to another embodiment of the present disclosure.

FIG. 14 is a cross-sectional view of a partial structure of the optical element driving mechanism 100 along the line C-C in FIG. 13 according to another embodiment of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

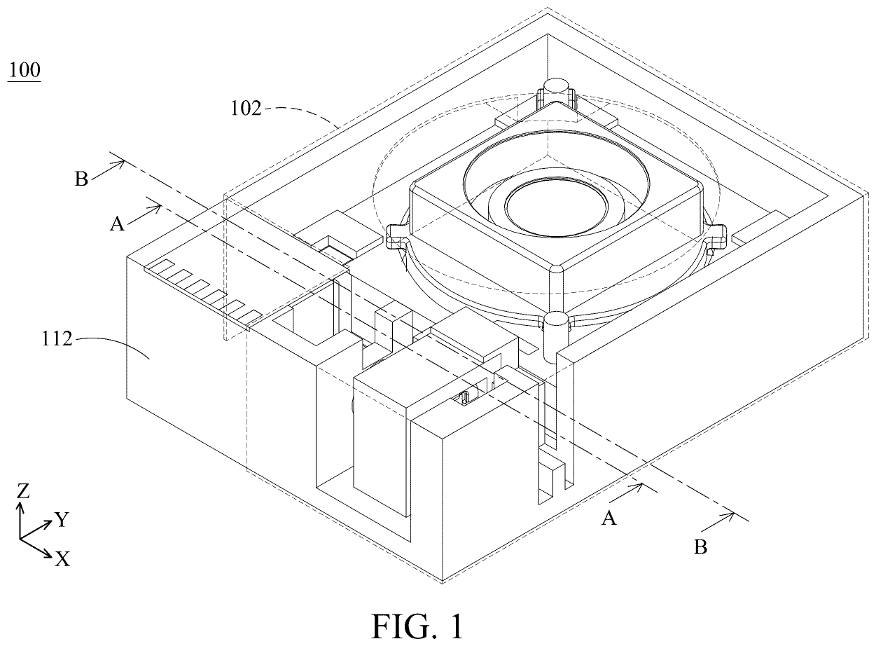

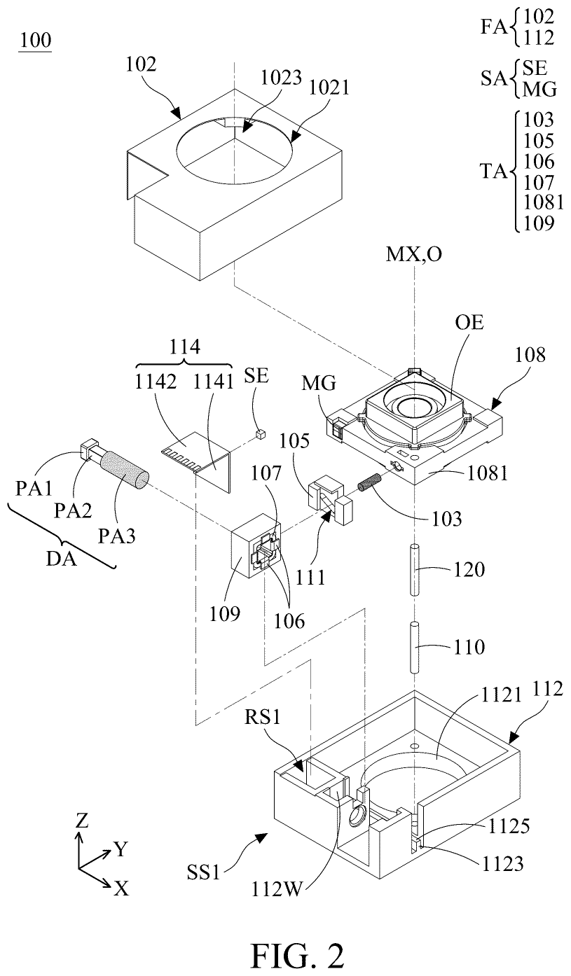

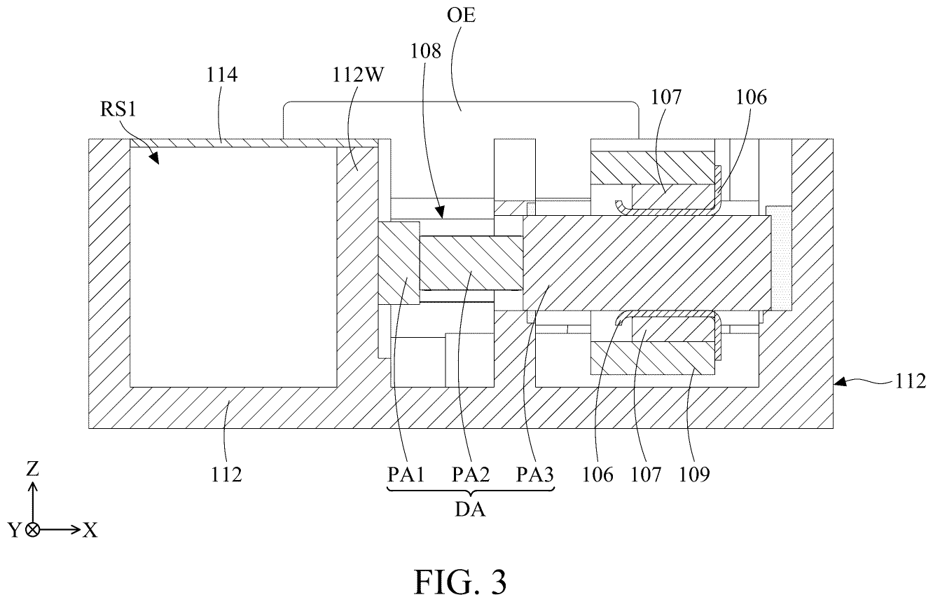

Please refer to FIG. 1 to FIG. 3. FIG. 1 is a schematic diagram of an optical element driving mechanism 100 according to an embodiment of the present disclosure, FIG. 2 is an exploded diagram of the optical element driving mechanism 100 according to an embodiment of the present disclosure, and FIG. 3 is a cross-sectional view of the optical element driving mechanism 100 along line A-A in FIG. 1 according to an embodiment of the present disclosure. The optical element driving mechanism 100 can be an optical camera system and can be configured to hold and drive an optical element OE (such a camera lens). The optical element driving mechanism 100 can be installed in various electronic devices or portable electronic devices, such as a smartphone, for allowing a user to perform the image capturing function. In this embodiment, the optical element driving mechanism 100 can be with an auto-focusing (AF) function, but it is not limited thereto. In other embodiments, the optical element driving mechanism 100 can also perform the functions of auto-focusing and optical image stabilization (OIS).

In this embodiment, the optical element driving mechanism 100 may include a fixed assembly FA, a movable part 108, and a driving assembly DA. The movable part 108 is configured to hold the aforementioned optical element OE (such as an optical lens), and the movable part 108 is movable relative to the fixed assembly FA. The driving assembly DA is configured to drive the movable part 108 to move relative to the fixed assembly FA.

In this embodiment, as shown in FIG. 2, the fixed assembly FA includes a casing 102 and a base 112. The casing 102 has a hollow structure, and a casing opening 1021 is formed on it. A base opening 1121 is formed on the base 112, the center of the casing opening 1021 corresponds to an optical axis O of the optical element OE, and the base opening 1121 corresponds to a photosensitive element (not shown in the figures) which is disposed below the base 112. External light can enter the casing 102 through the casing opening 1021 and to be received by the aforementioned photosensitive element after passing through the optical element and the base opening 1121 so as to generate a digital image signal. The photosensitive assembly 115 may, for example, be an image sensor, but it is not limited thereto.

Furthermore, the casing 102 and the base 112 are arranged along a main axis MX, and the casing 102 is fixedly disposed on the base 112. The main axis MX can overlap or be parallel to the optical axis O. The casing 102 may further have an accommodation space 1023 for accommodating components such as the movable part 108 and the driving assembly DA, and so on.

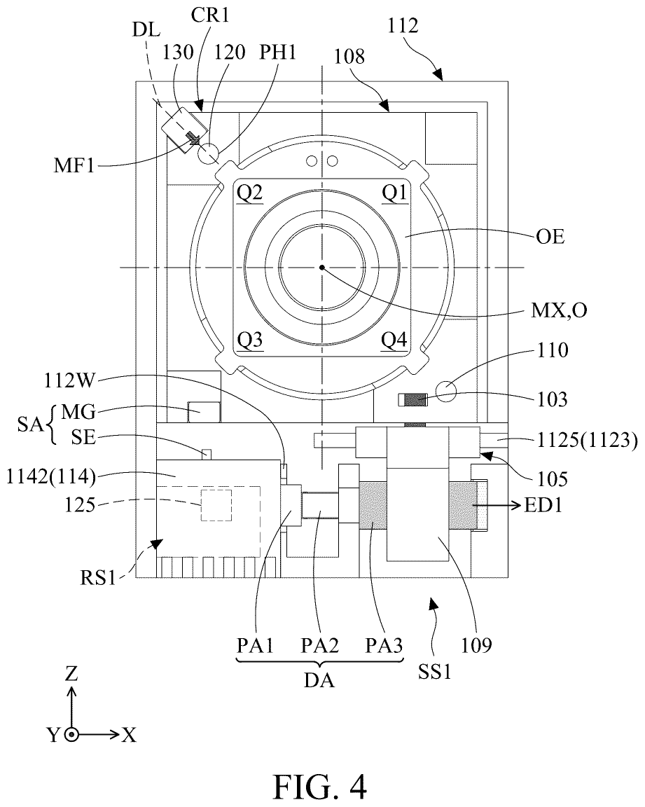

Furthermore, please refer to FIG. 2 and FIG. 4. FIG. 4 is a top view of a partial structure of the optical element driving mechanism 100 according to an embodiment of the present disclosure. As shown in FIG. 4, when viewed along the main axis MX, the base 112 of the fixed assembly FA has a polygonal structure, such as a rectangular structure.

As shown in FIG. 4, when viewed along the main axis MX, the driving assembly DA is located on a first side SS1 of the polygonal structure (that is, the bottom side of the rectangular structure). As shown in FIG. 2 and FIG. 4, the optical element driving mechanism 100 may further include a circuit assembly 114 which is electrically connected to the driving assembly DA. When viewed along main axis MX, the circuit assembly 114 is located on the first side SS1. The circuit assembly 114 is, for example, a flexible circuit board, but it is not limited thereto.

As shown in FIG. 2, the circuit assembly 114 may have an L-shaped structure, including a first circuit portion 1141 and a second circuit portion 1142. Correspondingly, the base 112 may have a separating wall 112W, and the first circuit portion 1141 and the second circuit portion 1142 are disposed on the separating wall 112W. When viewed along the main axis MX, the separating wall 112W is also located on the first side SS1.

Furthermore, as shown in FIG. 2 and FIG. 4, the optical element driving mechanism 100 further includes a sensing assembly SA which is configured to sense the movement of the movable part 108. Similarly, when viewed along the main axis MX, the sensing assembly SA is also located on the first side SS1.

In this embodiment, the sensing assembly SA may include a sensing element SE and a sensing magnet MG. The sensing magnet MG is disposed on the movable part 108, and the sensing element SE is disposed on the first circuit portion 1141 of the circuit assembly 114 and faces the sensing magnet MG. The sensing element SE is, for example, a Hall sensor or a tunnel magneto-resistive sensor (TMR sensor), and the sensing magnet MG is, for example, a multi-pole magnet, but they are not limited thereto.

In addition, in this embodiment, the optical element driving mechanism 100 may further include a control circuit 125 which is disposed on the second circuit portion 1142. When viewed along main axis MX, the second circuit portion 1142 shields the control circuit 125. The control circuit 125 is, for example, an integrated circuit or a chip, configured to be electrically connected to an external circuit, and controls the operation of the driving assembly DA according to signals from the external circuit.

Specifically, as shown in FIG. 2, the accommodation space 1023 may have a first receiving space RS1, and when viewed along the main axis MX, the first receiving space RS1 is located on the first side SS1. Specifically, the first receiving space RS1 is formed by the separating wall 112W and the casing 102, and the separating wall 112W is located between the first receiving space RS1 and the driving assembly DA.

In this embodiment, the control circuit 125 is accommodated in the first receiving space RS1, but it is not limited thereto. In other embodiments, a portion of the circuit assembly 114 or the sensing element SE can be accommodated in the first receiving space RS1.

In this embodiment, as shown in FIG. 2 and FIG. 3, the driving assembly DA is electrically connected to the circuit assembly 114 and can operate according to the control signal of the control circuit 125 on the circuit assembly 114 to operate to drive the movable part 108 to move along the main axis MX (or optical axis O).

Specifically, as shown in FIG. 2 and FIG. 3, the driving assembly DA may include an enhancing element PA1, a driving element PA2, and a transmission element PA3. The transmission element PA3 can have a long strip-shaped structure (such as a column structure), and the transmission element PA3 may be made of a carbon material, but they are not limited thereto.

The enhancing element PA1 can be, for example, a counterweight, but it is not limited thereto. In other embodiments, the enhancing element PA1 can also be a spring sheet. The driving element PA2 is, for example, a piezoelectric element, fixedly connected between the enhancing element PA1 and the transmission element PA3. In this embodiment, the driving element PA2 may have piezoelectric material. For example, the driving element PA2 is made of a ceramic material, but it is not limited thereto.

The driving element PA2 is configured to generate a first driving force, the enhancing element PA1 corresponds to the driving element PA2 and is configured to enhance the first driving force, and the transmission element PA3 is configured to transmit the first driving force. As shown in FIG. 4, when viewed along the main axis MX, the extending direction ED1 of the transmission element PA3 is parallel to the first side SS1.

Furthermore, the optical element driving mechanism 100 further includes a central assembly TA configured to transmit the first driving force to the movable part 108. That is, the first driving force can be transmitted to the movable part 108 through the transmission element PA3 and the central assembly TA to drive the movable part 108 to move along the main axis MX so as to achieve the purpose of autofocus.

As shown in FIG. 2 and FIG. 3, the central assembly TA may include two contact members 106, corresponding to the transmission element PA3 of the driving assembly DA and contacting the transmission element PA3. The central assembly TA may further include a force-applying member 107 which applies a supporting force on the two contact members 106, so that the contact member 106 clamps the transmission element PA3. In this embodiment, the contact member 106 is, for example, a metal spring sheet, and the force-applying member 107 is, for example, a rubber sleeve, but they are not limited thereto.

Furthermore, the central assembly TA may further include a first transmit member 103, a second transmit member 105, a first fixed element 1081 and a second fixed element 109. The first fixed element 1081 is configured to fix the first transmit member 103, and the second fixed element 109 is configured to fix the second transmit member 105.

In this embodiment, the first fixed element 1081 can be a part of the movable part 108. For example, the first fixed element 1081 and the movable part 108 are integrally formed as one piece, but they are not limited thereto. The second fixed element 109 has a frame-shaped structure and is configured to surround the force applying member 107. Specifically, the force applying member 107 is fixedly connected to the second fixed element 109 and is located between the transmission element PA3 and the second fixed element 109.

Furthermore, the second transmit member 105 corresponds to the first transmit member 103, and the second transmit member 105 is movable relative to the first transmit member 103, the first transmit member 103 is movable relative to the transmission element PA3, and the second transmit member 105 is movable relative to the transmission element PA3.

Specifically, the second transmit member 105 may have a first through groove 111, and the first transmit member 103 passes through the first through groove 111 and is located in the first through groove 111. Based on such a configuration, the first driving force is configured to be transmitted to the movable part 108 through the contact member 106, the force applying member 107, the second fixed element 109, the second transmit member 105, and the first transmit member 103. The specific action method will be described in the subsequent paragraphs.

In this embodiment, the Young's modulus of the first transmit member 103 and the second transmit member 105 are different. For example, the first transmit member 103 may be made of metal material, and the second transmit member 105 may be made of plastic material, such as resin material, but they are not limited thereto.

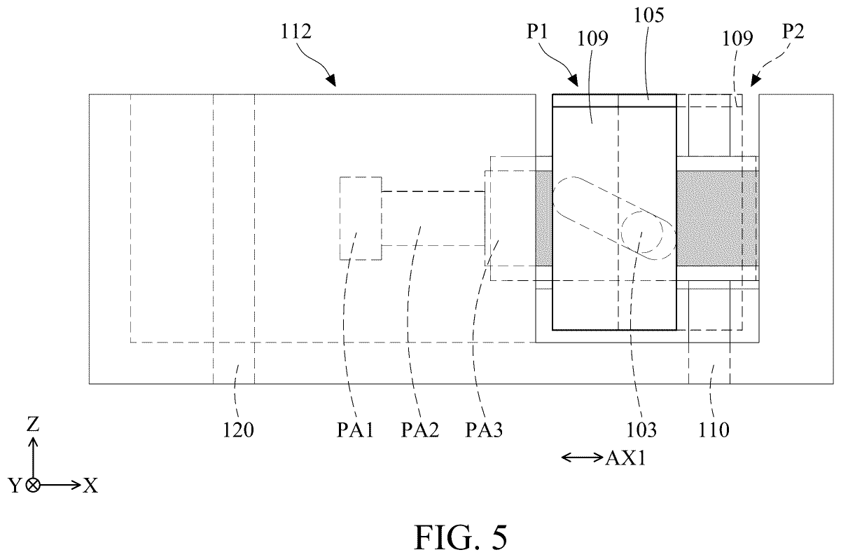

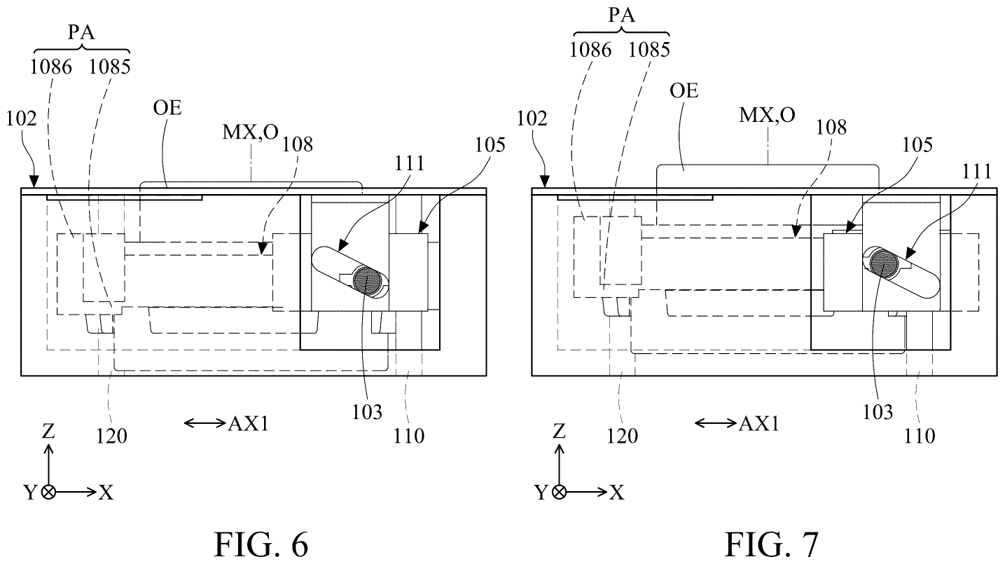

Next, please refer to FIG. 5 to FIG. 7. FIG. 5 is a front view of a partial structure of the optical element driving mechanism 100 according to an embodiment of the present disclosure, FIG. 6 is a schematic front view of the second transmit member 105 located in a first position according to an embodiment of the present disclosure, and FIG. 7 is a schematic front view of the second transmit member 105 located in a second position according to an embodiment of the present disclosure.

As shown in FIG. 5, when the driving element PA2 generates the first driving force, the first driving force can be transmitted to the second fixed element 109 through the transmission element PA3, the contact member 106 and the force applying member 107, so that the second fixed member 109 can move back and forth between a first position P1 and a second position P2 along a first axis AX1.

Correspondingly, as shown in FIG. 5 and FIG. 6, when the second fixed element 109 is located in the first position P1, the second transmit member 105 is also located in the first position P1 correspondingly, and the second transmit member 105 drives the first transmit member 103 and the movable part 108 to be located in a first extreme position in FIG. 6.

On the other hand, as shown in FIG. 5 and FIG. 7, when the second fixed element 109 moves from the first position P1 to the second position P2, the second transmit member 105 also moves correspondingly to be located in the second position P2, and the second transmit member 105 drives the first transmit member 103 and the movable part 108 to move from the first extreme position in FIG. 6 to a second extreme position in FIG. 7.

On the contrary, the second transmit member 105 can also drive the first transmit member 103 and the movable part 108 to move from the second extreme position in FIG. 7 to the first extreme position in FIG. 6. Based on this configuration, the movable part 108 can drive the optical element OE to move along the main axis MX to achieve the purpose of autofocus.

In addition, as shown in FIG. 2 and FIG. 4, in this embodiment, the optical element driving mechanism 100 may further include a protective element 110 which is fixedly disposed on the base 112 of the fixed assembly FA. The protective element 110 may be made of a metal material and have a columnar structure, such as a cylindrical structure. The protective element 110 extends along the main axis MX and passes through the movable part 108.

As shown in FIG. 2 and FIG. 4, the protective element 110 is arranged adjacent to the first transmit member 103. Specifically, as shown in FIG. 4, when viewed along the main axis MX, with the main axis MX as the origin, a first quadrant Q1, a second quadrant Q2, a third quadrant Q3 and a fourth quadrant Q4 can be defined, and when viewed along the main axis MX, the protective element 110 and the first transmit element 103 are located in the fourth quadrant Q4.

Based on the structural design and position configuration of the protective element 110, it can be ensured that the first driving force transmitted by the transmission element PA3 can be accurately transmitted to the movable part 108 through the second fixed member 109, the second transmit member 105 and the first transmit member 103 so as to achieve the best driving efficiency.

Next, please continue to refer to FIG. 2, FIG. 4 to FIG. 7. As shown in FIG. 6 and FIG. 7, because the first transmit element 103 is disposed on the right side of the movable part 108, when the driving assembly DA drives the movable part 108 to move along the main axis MX, the left side of the movable part 108 may be tilted towards the bottom of the base 112, causing unclear images.

In order to avoid the above situation, as shown in FIG. 2 and FIG. 4, the optical element driving mechanism 100 further includes a guiding element 120 and a first stabilizing element 130 to avoid the problem of tilting of the movable part 108 during movement. As shown in FIG. 2 and FIG. 4, the guiding element 120 is fixedly disposed at the base 112 of the fixed assembly FA.

Similarly, the guiding element 120 has a columnar structure, such as a cylindrical structure, extending along the main axis MX, and the guiding element 120 is configured to pass through the movable part 108. Furthermore, the first stabilizing element 130 is fixedly disposed on the movable part 108 and corresponds to the guiding element 120.

As shown in FIG. 4, when viewed along the main axis MX, the movable part 108 may have a rectangular structure. When viewed along the main axis MX, the guiding element 120 and the first stabilizing element 130 are located in a corner CRI of the rectangular structure. Specifically, when viewed along the main axis MX, the guiding element 120 and the first stabilizing element 130 are located in the second quadrant Q2.

Furthermore, as shown in FIG. 4, when viewed along the main axis MX, the first stabilizing element 130, and the guiding element 120 are arranged along a diagonal line DL of the rectangular structure in sequence.

In this embodiment, the first stabilizing element 130 has magnetic material. For example, the first stabilizing element 130 is a magnet, and the first stabilizing element 130 corresponds to the guiding element 120. For example, the guiding element 120 may be made of a magnetically permeable material, such as metal.

A magnetic attraction force MF1 can be generated between the guiding element 120 and the first stabilizing element 130, causing the first stabilizing element 130 to push the movable part 108 along the diagonal line DL (as shown by the arrow in FIG. 4), and the inner wall surface of a performance PHI of the movable part 108 can contact the guiding element 120 so as to increase the friction between the movable part 108 and the guiding element 120.

Based on this design, the aforementioned friction can avoid the aforementioned tilting problem of the movable part 108 during movement, and the friction does not affect the smoothness of the movable part 108 during movement along the main axis MX. Thereby, the imaging accuracy of the optical element driving mechanism 100 can be improved.

In addition, as shown in FIG. 6 and FIG. 7, the optical element driving mechanism 100 further includes a stopping assembly PA configured to limit the movement of the movable part 108 within a range of motion. At least a portion of the stopping assembly PA is disposed in the movable part 108. For example, the stopping assembly PA may include a first stopping structure 1085 and a second stopping structure 1086, which are disposed on the movable part 108.

Specifically, the first stopping structure 1085 and the second stopping structure 1086 are arranged on opposite sides of the movable part 108. As shown in FIG. 6, when the movable part 108 is located in a first extreme position, the first stopping structure 1085 is configured to be in contact with the base 112. On the other hand, when the movable part 108 is located in a second extreme position as shown in FIG. 7, the second stopping structure 1086 can be configured to be in contact with the casing 102.

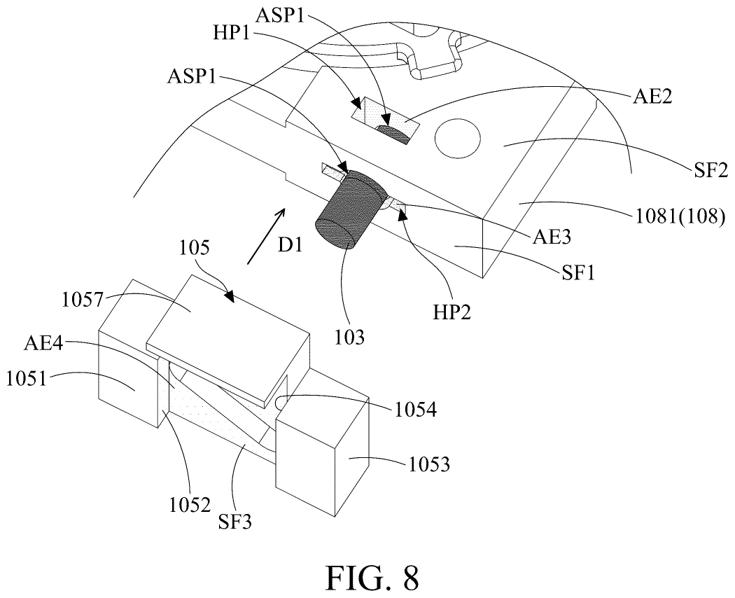

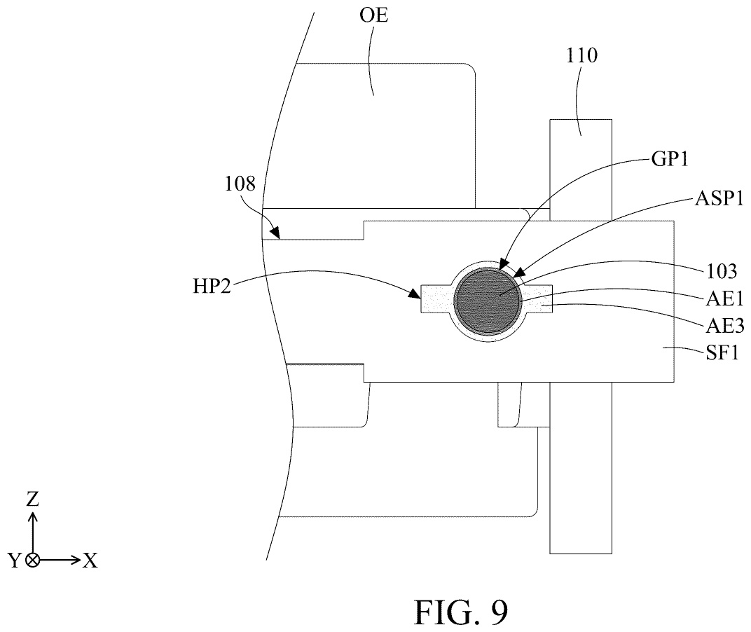

Please continue to refer to FIG. 8 and FIG. 9. FIG. 8 is a three-dimensional exploded diagram of a partial structure of the optical element driving mechanism 100 according to an embodiment of the present disclosure, and FIG. 9 is a front view of a partial structure of the optical element driving mechanism 100 according to an embodiment of the present disclosure. As shown in FIG. 8 and FIG. 9, the first fixed element 1081 is part of the movable part 108, such as a corner portion of the movable part 108 which includes a first surface SF1, a first accommodation portion ASP1 and a second surface SF2.

The first surface SF1 faces the second transmit member 105, and the first accommodation portion ASP1 has an opening structure which is formed on the first surface SF1 and is configured to accommodate at least a portion of the first transmit member 103.

Specifically, in this embodiment, the first transmit member 103 has a long strip-shaped structure which extends along a first direction D1, and the first accommodation portion ASP1 can be a cylindrical hole which is recessed from the first surface SF1 along the first direction D1. The first transmit member 103 is detachably installed in the first accommodation portion ASP1.

Furthermore, as shown in FIG. 8, the second surface SF2 is not parallel to the first surface SF1, for example, perpendicular to the first surface SF1. Furthermore, the optical element driving mechanism 100 further includes a first opening HP1 and a second opening HP2. The first opening HP1 is formed on the second surface SF2, and the first opening HP1 can be communicated with the first accommodation portion ASP1. At least a portion of the first transmit member 103 can be exposed from the first opening HP1.

As shown in FIG. 9, the optical element driving mechanism 100 may further include a first connection element AE1, which is partially located in the first accommodation portion ASP1. The first connection element AE1 is, for example, light-curing glue or thermosetting glue, but it is not limited thereto. The first transmit member 103 may be connected to the first fixed element 1081 via the first connection element AE1.

It is worth noting that, as shown in FIG. 9, a first gap GP1 may be formed between the first transmit member 103 and the first accommodation portion ASP1. That is, when viewed along the first direction D1 (such as parallel to the Y-axis), the diameter of the first accommodation portion ASP1 is greater than the diameter of the first transmit member 103, such as 5 to 10% greater.

Based on such a configuration, at least a portion of the first connection element AE1 can be located in the first gap GP1, so as to conveniently and effectively install the first transmit member 103 in the first accommodation portion ASP1.

Similarly, as shown in FIG. 8, the optical element driving mechanism 100 may further include a second connection element AE2, which is partially located in the first opening HP1. The second connection element AE2 is in direct contact with the first transmit member 103 and the first fixed element 1081, and the second connection element AE2 is in direct contact with the first connection element AE1.

The second connection element AE2 is, for example, light-curing glue or thermosetting glue, but it is not limited thereto. Based on the configuration of the first opening HP1, the operator can observe and confirm whether the first transmit member 103 is accurately installed on the movable part 108 when installing the first transmit member 103, thereby increasing the convenience during installation.

Furthermore, as shown in FIG. 8 and FIG. 9, the second opening HP2 is formed on the first surface SF1 and is adjacent to the first accommodation portion ASP1. For example, the second opening HP2 is communicated with the first accommodation portion ASP1. Similarly, the optical element driving mechanism 100 may further include a third connection element AE3, and at least a portion of the third connection element AE3 is located in the second opening HP2.

The third connection element AE3 is, for example, light-curing glue or thermosetting glue, but it is not limited thereto. The third connection element AE3 is in direct contact with the first transmit member 103 and the first fixed element 1081, and the third connection element AE3 is in direct contact with the first connection element AE1.

Based on this configuration, the operator can easily set the third connection element AE3 on the second opening HP2 on both sides of the first transmit member 103 to further affix the first transmit member 103 to the movable part 108.

It is worth noting that the third connection element AE3 can completely fill the second opening HP2, but the third connection element AE3 does not exceed the first surface SF1. Based on this configuration, it can be ensured that the third connection element AE3 does not contact the second transmit member 105 to avoid affecting the movement of the second transmit member 105.

In addition, in this embodiment, the first connection element AE1, the second connection element AE2 and the third connection element AE3 can be made of the same material. For example, these connection elements may have the same physical properties, such as the same Young's modulus, but they are not limited thereto. In other embodiments, these connection elements can be made of different materials so as to meet actual requirements.

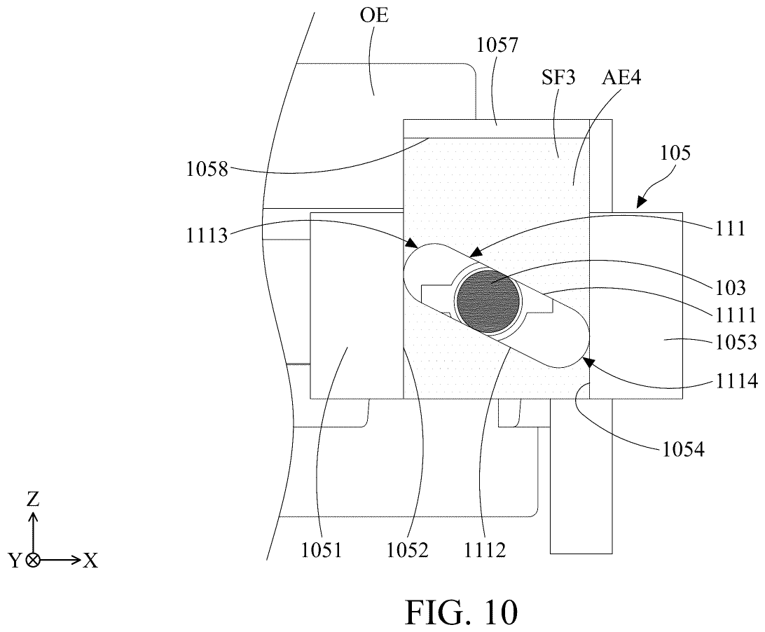

Next, please refer to FIG. 8 and FIG. 10. FIG. 10 is a front view of a partial structure of the optical element driving mechanism 100 according to an embodiment of the present disclosure. In this embodiment, as shown in FIG. 8 and FIG. 10, the second transmit member 105 has a third surface SF3 and the aforementioned first through groove 111, and the first through groove 111 is recessed from the third surface SF3. Specifically, the first through groove 111 penetrates the third surface SF3.

Furthermore, as shown in FIG. 10, the second transmitting member 105 of the central assembly TA may further include a first corresponding surface 1111 and a second corresponding surface 1112. The first corresponding surface 1111 faces the first transmit member 103, and the second corresponding surface 1112 faces the first transmit member 103.

As shown in FIG. 10, when viewed along the first direction D1, the first transmit member 103 is located between the first corresponding surface 1111 and the second corresponding surface 1112. The first corresponding surface 1111 and the second corresponding surface 1112 face different directions, and the first corresponding surface 1111 and the second corresponding surface 1112 are formed in the first through groove 111. The first corresponding surface 1111 may be parallel to the second corresponding surface 1112, but it is not limited thereto.

In this embodiment, the first through groove 111 has a long strip-shaped structure, and the first through groove 111 may further have a first end portion 1113 and a second end portion 1114, the first corresponding surface 1111 is located between the first end portion 1113 and the second end portion 1114, and the second corresponding surface 1112 is located between the first end portion 1113 and the second end portion 1114.

Specifically, the first corresponding surface 1111 is connected between the first end portion 1113 and the second end portion 1114, and the second corresponding surface 1112 is connected between the first end portion 1113 and the second end portion 1114. Therefore, as shown in FIG. 10, the first through groove 111 may be formed by the first corresponding surface 1111, the second corresponding surface 1112, the first end portion 1113 and the second end portion 1114.

It is worth noting that when the second transmit member 105 moves, the first transmit member 103 contacts the first corresponding surface 1111 and the second corresponding surface 1112. In addition, when the first transmit member 103 drives the movable part 108 to be located in any position within the range of motion, the first transmit member 103 is not in contact with the first end portion 1113, and when the first transmit member 103 drives the movable part 108 to be located in any position within the range of motion, the first transmit member 103 is not in contact with the second end portion 1114.

Please continue to refer to FIG. 8 and FIG. 10. In this embodiment, the second transmit member 105 may further include a first positioning portion 1051, and the first positioning portion 1051 has a first positioning surface 1052. The first positioning surface 1052 is not parallel to the third surface SF3. For example, the first positioning surface 1052 is perpendicular to the third surface SF3.

Similarly, the second transmit member 105 may further include a second positioning portion 1053, and the second positioning portion 1053 has a second positioning surface 1054. The second positioning surface 1054 is not parallel to the third surface SF3. For example, the second positioning surface 1054 is perpendicular to the third surface SF3.

In this embodiment, the second positioning surface 1054 and the first positioning surface 1052 face different directions. Specifically, the second positioning surface 1054 and the first positioning surface 1052 are opposite to each other.

Based on this configuration, the first positioning portion 1051 and the second positioning portion 1053 can clamp the second fixed element 109 so that the second fixed element 109 is positioned between the first positioning portion 1051 and the second positioning portion 1053.

Furthermore, the optical element driving mechanism 100 may further include a fourth connection element AE4, and the second transmit member 105 is connected to the second fixed element 109 via the fourth connection element AE4. The fourth connection element AE4 is, for example, light-curing glue or thermosetting glue, but it is not limited thereto.

The fourth connection element AE4 is in direct contact with the third surface SF3, the fourth connection element AE4 is in direct contact with the first positioning surface 1052, and the fourth connection element AE4 is in direct contact with the second positioning surface 1054, so that the second fixed element 109 may be affixed to the second transmit member 105.

Based on the above-mentioned configuration of the first positioning portion 1051, the second positioning portion 1053, and the fourth connection element AE4, it can be ensured that when the second fixed element 109 moves, the second transmit member 105 is not separated from the second fixed element 109.

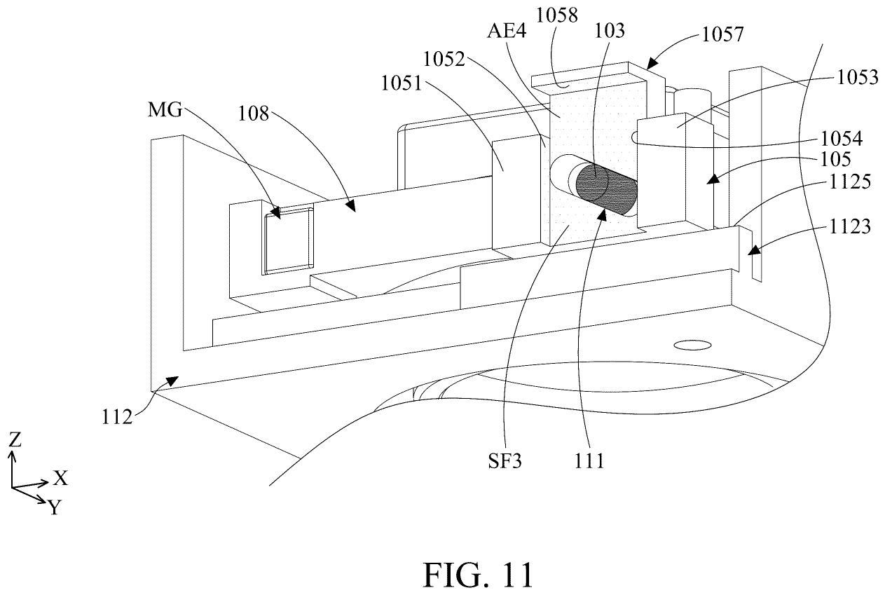

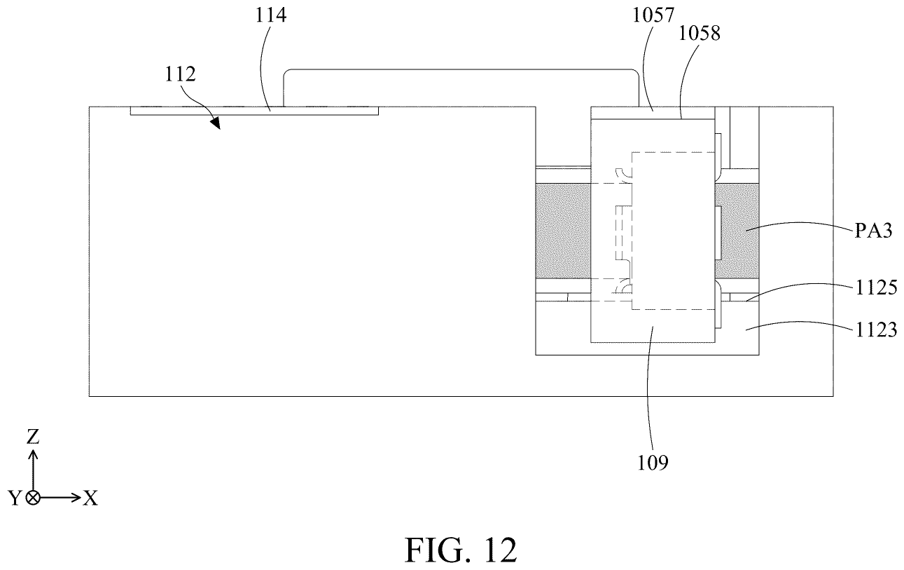

Next, please refer to FIG. 2, FIG. 11 and FIG. 12. FIG. 11 is a three-dimensional cross-sectional view of the partial structure of the optical element driving mechanism 100 along line B-B in FIG. 1 according to an embodiment of the present disclosure, and FIG. 12 is a front view of the partial structure of the optical element driving mechanism 100 according to an embodiment of the present disclosure. In this embodiment, the base 112 may include a third positioning portion 1123 which protrudes along the main axis MX (the Z-axis).

For example, the third positioning portion 1123 is, for example, a rectangular bump, and the third positioning portion 1123 may have a third positioning surface 1125. The third positioning surface 1125 is, for example, the top surface of the third positioning portion 1123. The third positioning surface 1125 and the first positioning surface 1052 face different directions, and the third positioning surface 1125 and the second positioning surface 1054 also face different directions.

Similarly, the third positioning surface 1125 is not parallel to the third surface SF3. For example, the third positioning surface 1125 is perpendicular to the third surface SF3, but it is not limited thereto. There is a gap between the second transmit member 105 and the third positioning surface 1125, so that the second transmit member 105 can move relative to the third positioning surface 1125.

It is worth noting that the aforementioned fourth connection element AE4 does not contact the third positioning surface 1125. That is, the fourth connection element AE4 does not affect the movement of the second transmit member 105. In addition, based on the configuration of the third positioning portion 1123, the operator's convenience when installing the second transmit member 105 can be increased.

In addition, in this embodiment, the second transmit member 105 further includes a fourth positioning portion 1057 which extends from the third surface SF3, and the fourth positioning portion 1057 has a fourth positioning surface 1058. The fourth positioning surface 1058 is, for example, the bottom surface of the fourth positioning portion 1057, but it is not limited thereto.

As shown in FIG. 11, the fourth positioning surface 1058 and the first positioning surface 1052 face different directions, the fourth positioning surface 1058 and the second positioning surface 1054 face different directions, the fourth positioning surface 1058 and the third positioning surface 1125 faces different directions, and the fourth positioning surface 1058 is not parallel to the third surface SF3.

As shown in FIG. 12, when viewed in the direction perpendicular to the third surface SF3, such as viewed along the Y-axis, the transmission element PA3 is located between the third positioning surface 1125 and the fourth positioning surface 1058.

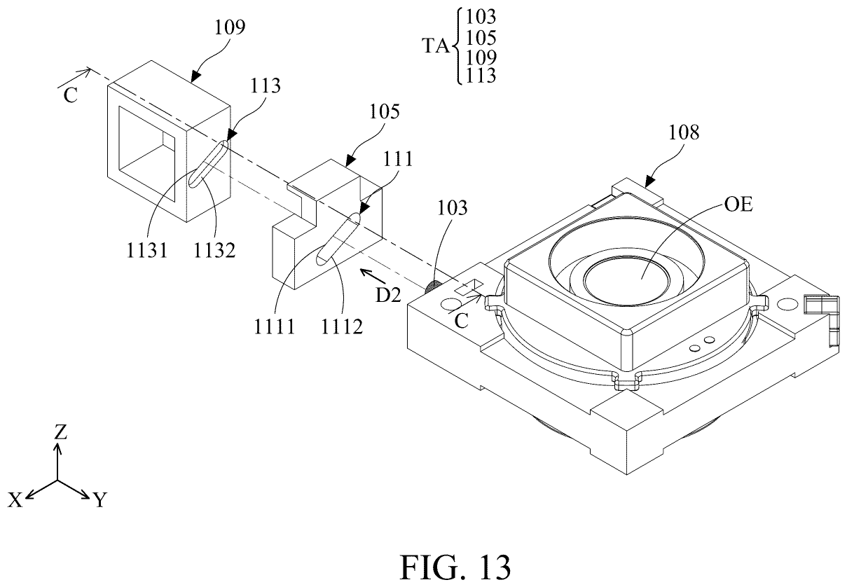

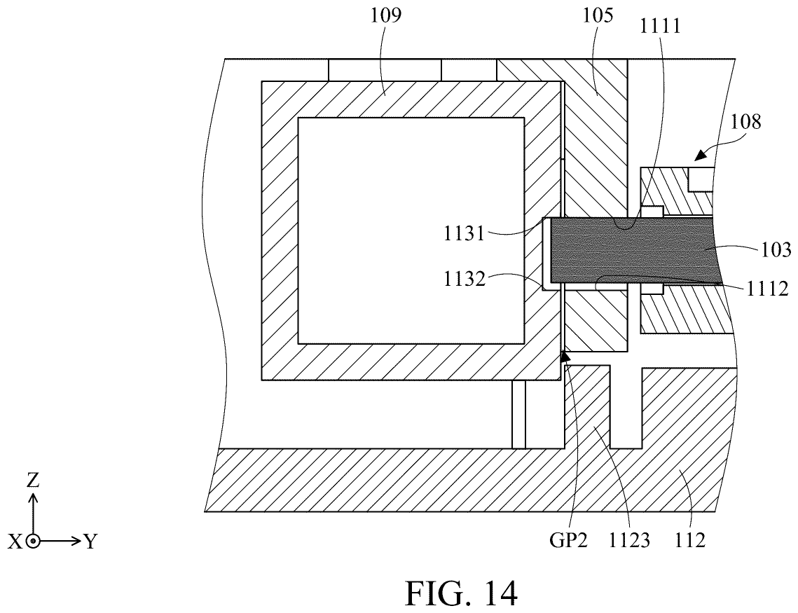

Next, please refer to FIG. 13 and FIG. 14. FIG. 13 is an exploded diagram of a partial structure of the optical element driving mechanism 100 according to another embodiment of the present disclosure, and FIG. 14 is a cross-sectional view of a partial structure of the optical element driving mechanism 100 along the line C-C in FIG. 13 according to another embodiment of the present disclosure. In this embodiment, the central assembly TA may further include a second through groove 113. The second through groove 113 has a recessed structure and is formed on the second fixed element 109.

In this embodiment, the second through groove 113 does not penetrate the second fixed element 109, but it is not limited thereto. In other embodiments, the second through groove 113 may have an opening structure and penetrate the second fixed element 109.

Furthermore, the second through groove 113 on the second fixed element 109 may have a third corresponding surface 1131, facing the first transmit member 103, and the second through groove 113 may further have a fourth corresponding surface 1132, facing the first transmit member 103.

As shown in FIG. 13, when viewed along the extending direction of the first transmit member 103, for example, when viewed along a second direction D2, the first transmit member 103 is located between the third corresponding surface 1131 and the fourth corresponding surface 1132 after assembly. The second direction D2 is opposite to the first direction D1.

In this embodiment, the third corresponding surface 1131 is parallel to the first corresponding surface 1111, and the fourth corresponding surface 1132 is parallel to the second corresponding surface 1112. For example, the second through groove 113 may have the same contour as the first through groove 111, but it is not limited thereto.

It is worth noting that, as shown in FIG. 14, the third corresponding surface 1131 is not connected to the first corresponding surface 1111, and the fourth corresponding surface 1132 is not connected to the second corresponding surface 1112. That is, there is a gap GP2 between the third corresponding surface 1131 and the first corresponding surface 1111, and there is also the aforementioned gap GP2 between the fourth corresponding surface 1132 and the second corresponding surface 1112.

In conclusion, the present disclosure provides an optical element driving mechanism 100 which includes a fixed assembly FA, a movable part 108, and a driving assembly DA. The movable part 108 is movable relative to the fixed assembly FA, and the driving assembly DA is configured to drive the movable part 108 to move relative to the fixed assembly FA. Furthermore, the optical element driving mechanism 100 further includes a central assembly TA, and the driving assembly DA drives the movable part 108 to move through the central assembly TA.

In some embodiments, the central assembly TA includes a first transmit member 103, a second transmit member 105, and a second fixed element 109. The first transmit member 103 is fixedly connected to the movable part 108, the second transmit member 105 is affixed to the second fixed element 109, and the second fixed element 109 is sleeved on the transmission element PA3 of the driving assembly DA. When the driving assembly DA provides the first driving force, the second fixed element 109 drives the second transmit member 105 to move along the first axis AX1.

Furthermore, a first through groove 111 is formed on the second transmit member 105, and the first transmit member 103 has a cylindrical structure and passes through the first through groove 111. When the second transmit member 105 moves along the first axis AX, the first transmit member 103 is driven to drive the movable part 108 to move along the main axis MX. The extending direction of the first through groove 111 is not parallel to the first axis AX or the main axis MX. In addition, in some embodiments, the positions of the first transmit member 103 and the first through groove 111 can be interchanged. For example, the first transmit member 103 is provided on the second fixed element 109, and the first through groove 111 is formed on the movable part 108. Therefore, the optical element driving mechanism 100 can effectively reduce the structural size along the main axis MX so as to achieve the purpose of miniaturization.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. An optical element driving mechanism, comprising:
a fixed assembly, having a main axis;
a movable part, configured to be connected to an optical element, wherein the movable part is movable relative to the fixed assembly; and
a driving assembly, configured to drive the movable part to move relative to the fixed assembly.

2. The optical element driving mechanism as claimed in claim 1, wherein
when viewed along the main axis, the fixed assembly has a polygonal structure;
when viewed along the main axis, the driving assembly is located on a first side of the polygonal structure;
the optical element driving mechanism further includes a circuit assembly which is electrically connected to the driving assembly;
when viewed along the main axis, the circuit assembly is located on the first side; and
the circuit assembly has an L-shaped structure, which includes a first circuit portion and a second circuit portion.

3. The optical element driving mechanism as claimed in claim 2, wherein
the optical element driving mechanism further includes a sensing assembly configured to sense movement of the movable part;
when viewed along the main axis, the sensing assembly is located on the first side;
the sensing assembly includes a sensing element and a sensing magnet;
the sensing magnet is disposed on the movable part;
the sensing element is disposed on the first circuit portion of the circuit assembly and faces the sensing magnet;
the optical element driving mechanism further includes a control circuit which is disposed on the second circuit portion; and
when viewed along the main axis, the second circuit portion shields the control circuit.

4. The optical element driving mechanism as claimed in claim 3, wherein
the driving assembly further includes a driving element, a transmission element and an enhancing element;
the driving element is connected between the enhancing element and the transmission element;
the driving element is configured to generate a first driving force;
the transmission element has a long strip-shaped structure configured to transmit the first driving force;
the enhancing element corresponds to the driving element and is configured to enhance the first driving force;
the driving element has piezoelectric material; and
when viewed along the main axis, an extending direction of the transmission element is parallel to the first side.

5. The optical element driving mechanism as claimed in claim 4, wherein
the fixed assembly further includes a first receiving space, and at least a portion of the control circuit or the sensing assembly is located in the first receiving space;
when viewed along the main axis, the first receiving space is located on the first side;
the fixed assembly further includes a separating wall which is located between the first receiving space and the driving assembly; and
when viewed along the main axis, the separating wall is located on the first side.

6. The optical element driving mechanism as claimed in claim 5, wherein
the optical element driving mechanism further includes a central assembly which is configured to transmit the first driving force to the movable part;
the central assembly includes a first transmit member and a second transmit member;
the first transmit member has a long strip-shaped structure;
the second transmit member corresponds to the first transmit member, and the second transmit member is movable relative to the first transmit member;
the first transmit member is movable relative to the transmission element; and
the second transmit member is movable relative to the transmission element.

7. The optical element driving mechanism as claimed in claim 6, wherein
the central assembly further includes a contact member and a force applying member;
the contact member is configured to clamp the transmission element;
the force applying member is configured to apply a supporting force on the contact member;
the optical element driving mechanism further includes a first fixed element which is configured to fix the first transmit member;
the optical element driving mechanism further includes a second fixed element which is configured to fix the second transmit member;
the force applying member is fixedly connected to the second fixed element and is located between the transmission element and the second fixed element; and
the first driving force is configured to be transmitted to the movable part through the contact member, the force applying member, the second fixed element, the second transmit member and the first transmit member.

8. The optical element driving mechanism as claimed in claim 7, wherein
the first fixed element includes a first surface, a first accommodation portion and a second surface;
the first surface faces the second transmit member;
the first accommodation portion has an opening structure which is formed on the first surface and is configured to accommodate at least a portion of the first transmit member;
the second surface is not parallel to the first surface;
the optical element driving mechanism further includes a first opening and a second opening;
the first opening is formed on the second surface, and at least a portion of the first transmit member is exposed from the first opening;
the first opening is communicated with the first accommodation portion; and
the second opening is formed on the first surface and adjacent to the first accommodation portion.

9. The optical element driving mechanism as claimed in claim 8, wherein
the optical element driving mechanism further includes a first connection element which is partially located in the first accommodation portion;
the first transmit member is connected to the first fixed element via the first connection element;
a first gap is formed between the first transmit member and the first accommodation portion;
at least a portion of the first connection element is located in the first gap;
the optical element driving mechanism further includes a second connection element which is partially located on the first opening;
the second connection element is in direct contact with the first transmit member and the first fixed element; and
the second connection element is in direct contact with the first connection element.

10. The optical element driving mechanism as claimed in claim 9, wherein
the optical element driving mechanism further includes a third connection element, and at least a portion of the third connection element is located in the second opening;
the third connection element is in direct contact with the first transmit member and the first fixed element;
the third connection element is in direct contact with the first connection element; and
the third connection element does not exceed the first surface.

11. The optical element driving mechanism as claimed in claim 10, wherein
the central assembly further includes a first corresponding surface and a second corresponding surface;
the first corresponding surface faces the first transmit member;
the second corresponding surface faces the first transmit member;
the first transmit member has a long strip-shaped structure which extends along a first direction;
when viewed along the first direction, the first transmit member is located between the first corresponding surface and the second corresponding surface; and
the first corresponding surface and the second corresponding surface face different directions.

12. The optical element driving mechanism as claimed in claim 11, wherein
the second transmit member has a third surface and a first through groove;
the first through groove is recessed from the third surface;
the first transmit member passes through the first through groove;
the first corresponding surface and the second corresponding surface are formed in the first through groove;
the first through groove has a long strip-shaped structure;
the first through groove has a first end portion and a second end portion;
the first corresponding surface is located between the first end portion and the second end portion; and
the second corresponding surface is located between the first end portion and the second end portion.

13. The optical element driving mechanism as claimed in claim 12, wherein
the second transmit member further includes a first positioning portion, and the first positioning portion has a first positioning surface;
the first positioning surface is not parallel to the third surface;
the second transmit member further includes a second positioning portion, and the second positioning portion has a second positioning surface;
the second positioning surface and the first positioning surface face different directions; and
the second positioning surface is not parallel to the third surface.

14. The optical element driving mechanism as claimed in claim 13, wherein
the optical element driving mechanism further includes a fourth connection element, and the second transmit member is connected to the second fixed element via the fourth connection element;
the fourth connection element is in direct contact with the third surface;
the fourth connection element is in direct contact with the first positioning surface; and
the fourth connection element is in direct contact with the second positioning surface.

15. The optical element driving mechanism as claimed in claim 14, wherein
the fixed assembly further includes a third positioning portion, and the third positioning portion has a third positioning surface;
the third positioning surface and the first positioning surface face different directions;
the third positioning surface is not parallel to the third surface;
the fourth connection element does not contact the third positioning surface; and
the second transmit member is movable relative to the third positioning surface.

16. The optical element driving mechanism as claimed in claim 15, wherein
the second transmit member further includes a fourth positioning portion, and the fourth positioning portion has a fourth positioning surface;
the fourth positioning surface and the first positioning surface face different directions;
the fourth positioning surface and the second positioning surface face different directions;
the fourth positioning surface and the third positioning surface face different directions; and
the fourth positioning surface is not parallel to the third surface.

17. The optical element driving mechanism as claimed in claim 16, wherein
when viewed in a direction perpendicular to the third surface, the transmission element is located between the third positioning surface and the fourth positioning surface;
the Young's modulus of the first transmit member and the second transmit member are different;
the first transmit member includes metal material; and
the second transmit member includes plastic material.

18. The optical element driving mechanism as claimed in claim 17, wherein
the optical element driving mechanism further includes a stopping assembly which is configured to limit movement of the movable part within a range of motion;
when the movable part is located in any position within the range of motion, the first transmit member does not contact the first end portion;
when the movable part is located in any position within the range of motion, the first transmit member does not contact the second end portion; and
at least a portion of the stopping assembly is disposed in the movable part.

19. The optical element driving mechanism as claimed in claim 8, wherein
the central assembly further includes a second through groove which has a third corresponding surface facing the first transmit member;
the second through groove has a fourth corresponding surface facing the first transmit member;
when viewed along an extending direction of the first transmit member, the first transmit member is located between the third corresponding surface and the fourth corresponding surface; and
the third corresponding surface is parallel to the first corresponding surface.

20. The optical element driving mechanism as claimed in claim 19, wherein
the second through groove has a recessed structure or an opening structure which is formed on the second fixed element;
the third corresponding surface is not connected to the first corresponding surface; and
there is a gap between the third corresponding surface and the first corresponding surface.
